(19) United States
(12) Patent Application Publication
(10) Pub. No.: US 2004/0134894 A1
(43) Pub. Date: Jul. 15, 2004

(54) Laser-based system for memory link processing with picosecond lasers

(76) Inventors: Bo Gu, North Andover, MA (US); Donald V. Smart, Boston, MA (US); James J. Cordingley, Littleton, MA (US); Joohan Lee, Andover, MA (US); Donald J. Svetkoff, Ann Arbor, MI (US); Shepard D. Johnson, Andover, MA (US); Jonathan S. Ehrmann, Sudbury, MA (US)

Correspondence Address: BROOKS KUSHMAN P.C., 1000 TOWN CENTER, TWENTY-SECOND FLOOR, SOUTHFIELD, MI, 48075, US

(21) Appl. No.: 10/683,147

(22) Filed: Oct. 10, 2003

Related U.S. Application Data
(63) Continuation-in-part of application No. 09/941,389, filed on Aug. 28, 2001, now Pat. No. 6,727,458.
Application No. 09/941,389 is a continuation of application No. 09/473,926, filed on Dec. 28, 1999, now Pat. No. 6,281,471.
(63) Continuation-in-part of application No. 10/107,890, filed on Mar. 27, 2002.
(60) Provisional application No. 60/279,644, filed on Mar. 29, 2001.

(51) Int. Cl. B23K 26/36

(52) U.S. Cl. 219/121.68

(57) ABSTRACT

A laser-based system for processing target material within a microscopic region without causing undesirable changes in electrical or physical characteristics of at least one material surrounding the target material, the system includes a seed laser, an optical amplifier, and a beam delivery system. The seed laser for generating a sequence of laser pulses having a first pre-determined wavelength. The optical amplifier for amplifying at least a portion of the sequence of pulses to obtain an amplified sequence of output pulses. The beam delivery system for delivering and focusing at least one pulse of the amplified sequence of pulses onto the target material. The at least one output pulse having a pulse duration in the range of about 10 picoseconds to less than 1 nanosecond. The pulse duration being within a thermal processing range. The at least one focused output pulse having sufficient power density at a location within the target material to reduce the reflectivity of the target material and efficiently couple the focused output into the target material to remove the target material.

### CROSS-REFERENCE TO RELATED APPLICATIONS

This application is a continuation in part of U.S. Ser. No. 09/941,389 entitled “Energy-Efficient, Laser Based Method and System for Processing Target Material”, filed 28 Aug. 2001, which is a continuation of U.S. Ser. No. 09/473,926, filed 28 Dec. 1999, now U.S. Pat. No. 6,281,471. The disclosure of U.S. Pat. No. 6,281,471 is hereby incorporated by reference in its entirety. This application is also a continuation in part of U.S. Ser. No. 10/107,890 entitled “Methods and Systems for Thermal-Based Laser Processing a Multi-Material Device” filed 27 Mar. 2002, which claims the benefit of U.S. Provisional Application Ser. No. 60/279,644, filed 29 Mar. 2001. The disclosure of U.S. Ser. No. 10/107,890, now published as U.S. patent application Publication Number 2002/0167581, is hereby incorporated by reference in its entirety.

### BACKGROUND OF THE INVENTION

1. Field of the Invention

The present invention relates to the field of laser processing methods and systems, and specifically, to laser processing methods and systems for processing target material in a microscopic region, for instance laser based micromachining of target material on a substrate. This invention is particularly applicable, but not limited to, laser repair of redundant semiconductor memory devices.

2. Background Art

Economics and device performance have driven the size for the DRAMs and logic devices to very small physical dimensions. Not only are the devices small, but the interconnects and links thickness have also decreased dramatically in recent years.

General information regarding laser-based material processing is available in “HANDBOOK OF LASER MATERIAL PROCESSING”, Laser Institute of America (2003). Subject matter includes laser drilling, cutting, trimming, micromachining, and link cutting/making.

Some thermal laser processing of links, for example, as described in “Link Cutting/Making” in HANDBOOK OF LASER MATERIALS PROCESSING, Chapter 19, pp. 595-615, Laser Institute of America (2001), relies on the differential thermal expansion between the oxide above the link and the link itself. The differential expansion results in a high pressure build-up of the molten link contained by the oxide. The oxide over the link is necessary to contain the link in a molten state long enough to build-up sufficient pressure to crack the oxide and explosively expel the link material. If the pressure is too low, the link will not be removed cleanly. Alternative laser wavelengths and laser control strive to increase the laser “energy window” without damaging the substrate and material contiguous to the link.

Further information is available regarding link blowing methods and systems, including material processing, system design, and device design considerations, in the following representative U.S. patents and published U.S. applications: U.S. Pat. Nos. 4,399,345; 4,532,402; 4,826,785; 4,935,801; 5,059,764; 5,208,437; 5,265,114; 5,473,624; 6,057,180; 6,172,325; 6,191,486; 6,239,406; 2002-0003130; and 2002-0005396.

Other representative publications providing background on link processing of memory circuits or similar laser processing applications include: “Laser Adjustment of Linear Monolithic Circuits,” Litwin and Smart, ICAELO, (1983); “Computer Simulation of Target Link Explosion In Laser Programmable Memory,” Scarfone, Chlipala (1986); “Precision Laser Micromachining,” Boogard, SPIE Vol. 611 (1986); “Laser Processing for Application Specific Integrated Circuits (asics),” SPIE Vol. 774, Smart (1987); “Xenon Laser Repairs Liquid Crystal Displays,” Waters, Laser and Optronics, (1988); “Laser Beam Processing and Wafer Scale Integration,” Cohen (1988); “Optimization of Memory Redundancy Link Processing,” Sun, Harris, Swenson, Hutchens, Vol. SPIE 2636, (1995); “Analysis of Laser Metal Cut Energy Process Window,” Bernstein, Lee, Yang, Dahmas, IEEE Trans. On Semicond. Manufact., Vol 13, No. 2. (2000); “Link Cutting/Making” in HANDBOOK OF LASER MATERIALS PROCESSING, Chapter 19, pp. 595-615, Laser Institute of America (2001).

Requirements for the next generation of dynamic random access memory (DRAM) include fine pitch links having link widths less than 0.5 microns and link pitch (center to center spacing) less than 2 microns (e.g., 1.33 microns). Current commercial laser memory link repair systems, which use Q-switched, Nd based solid-state lasers with wavelengths of about 1 to 1.3 microns and pulse widths about 4 to 50 nanoseconds (ns), are not well suited for meeting such requirements. The large (wavelength limited) spot size and thermal effect (pulse width limited) are two limiting factors.

In INTERNATIONAL JOURNAL OF ADVANCED MANUFACTURING TECHNOLOGY (2001) 18:323-331, results of copper laser processing are disclosed. A frequency tripled Nd:YAG laser with 50 nanosecond (ns) pulse duration was used. The measured heat affected zones (HAZ) were about 1 micron for 6×10⁸ W/cm² irradiance and more than 3 microns for about 2.5×10⁹ W/cm² irradiance.

Attempts have been made to address the problems. Reference is made to the following U.S. patents and published applications: 5,208,437; 5,656,186; 5,998,759; 6,057,180, 6,300,590; 6,574,250; WO 03/052890; and European patent EP 0902474. In summary, the conventional q-switched, nanosecond solid state lasers, even at short wavelengths, are not able to process the fine pitch links due to its thermal process nature. Material interaction may be a substantially non-thermal process at femtosecond pulse widths, but the complexity, high costs, and reliability of femtosecond pulse lasers may limit practical implementations. Device and material modifications to support laser repair are expensive and alone may not be sufficient. An improved method and system for fine pitch link processing is needed to circumvent problems associated with thermal effects yet provide for efficient link removal at high repetition rates without the complexity associated with femtosecond laser systems.

### SUMMARY OF THE INVENTION

An object of the present invention is to provide a method or apparatus for improving the quality of laser processing (i.e., removal, ablation, severing, “blowing,” etc.) of memory links.

Another object of the present invention is to provide a method or apparatus for laser processing of target material in a microscopic region.

In carrying out the above objects of the present invention, a laser-based system for processing target material within a microscopic region without causing undesirable changes in electrical or physical characteristics of at least one material surrounding the target material is provided. The system comprises a seed laser, an optical amplifier, and a beam delivery system. The seed laser for generating a sequence of laser pulses having a first pre-determined wavelength. The optical amplifier for amplifying at least a portion of the sequence of pulses to obtain an amplified sequence of output pulses. The beam delivery system for delivering and focusing at least one pulse of the amplified sequence of pulses onto the target material. The at least one output pulse having a pulse duration in the range of about 10 picoseconds to less than 1 nanosecond. The pulse duration being within a thermal processing range. The at least one focused output pulse having sufficient power density at a location within the target material to reduce the reflectivity of the target material and efficiently couple the focused output into the target material to remove the target material.

The system may further include a deflector for delivering the sequence of pulses.

The system may include an anamorphic optical sub-system for producing a non-round focused output pulse.

The system may include a pre-amplifier for pre-amplifying the seed laser sequence to a predetermined pulse energy level prior to the optical amplifying.

The system may further include a shifter for shifting the first wavelength to a second wavelength prior to the optical amplifying.

The system may further include a modulator for controllably selecting at least a portion of the amplified sequence of pulses based on position or velocity information to synchronize a link and laser beam position during relative motion so as to provide the at least one output pulse subsequent to the optical amplifying.

The system may further include a modulator for controllably selecting at least a portion of the sequence of pulses based on position or velocity information to synchronize a link and laser beam position during relative motion so as to provide at least one pulse to process the target link on demand prior to the optical amplifying.

The system the sequence of laser pulses may have a repetition rate that is greater than about 1 MHz and wherein a modulator controllably selects the sequence of pulses to reduce the repetition rate to within the range of about 10 Khz to 100 Khz.

The system the sequence of laser pulses may include at least one pulse having a nanosecond duration greater than about 1 nanosecond, and the system further includes a modulator for compressing or slicing the at least one nanosecond pulse to produce a pulse having the duration in the range of about 10 ps to less than 1 ns.

The at least one seed laser may be a q-switched microlaser or laser diode.

The modulator may be a compressor disposed between the seed laser and the amplifier and compressing is performed prior to amplifying.

The modulator may be a slicer disposed after the amplifier and slicing is performed subsequent to amplifying.

The seed laser may be a diode pumped solid state laser.

The diode pumped solid-state laser may be a fiber laser.

The seed laser may be an active or passive mode locked laser.

The seed laser may be a high speed semiconductor laser diode.

Amplifying may be performed using at least one fiber optic amplifier.

The fiber optic amplifier may have a gain of about 30 dB.

The system may further include a shifter for shifting the laser wavelength of at least one pulse of the amplified sequence of pulses from the first wavelength to a second wavelength less than about one micron.

Further in carrying out the objects of the present invention, a laser-based system for processing target material within a microscopic region without causing undesirable changes in electrical or physical characteristics of at least one material surrounding the target material is provided. The system comprises means for generating a sequence of laser pulses, modulator means, and means for delivering and focusing the at least one output pulse. Each pulse of the sequence of pulses may have a pulse duration in the range of about 10 picoseconds to less than 1 nanosecond, the pulse duration being within a thermal processing range. The modulator means may be for controllably selecting at least a portion of the sequence of pulses to provide at least one output pulse to process the target material on demand. The at least one output pulse may be delivered and focused onto the target material. The means for delivering and focusing may comprise an optical system. The at least one focused output pulse may have sufficient power density at a location within the target material to reduce the reflectivity of the target material and efficiently couple the focused output into the target material to remove the target material.

The sequence of laser pulses may be an amplified sequence of pulses, and wherein the means for generating may include a master oscillator and power amplifier (MOPA).

The system modulator means may include an acousto-optic modulator or electro-optic modulator.

The electro-optic modulator may be a Mach-Zehnder modulator.

The means for delivery may include a beam deflector for deflecting at least one pulse to the target material based on at least of one position and velocity information of the target material relative to the at least one pulse.

Yet further in carrying out the objects of the present invention, a laser-based system for processing target material within a microscopic region without causing undesirable changes in electrical or physical characteristics of at least one material surrounding the target material is provided. The system comprises a first laser and a second laser, a beam combiner for combining the pulses, at least one optical amplifier, and a beam delivery system. The first laser and a second laser may be for producing a plurality laser pulses having a temporal spacing between the pulses. The at least one optical amplifier may be for amplifying at least a portion of the plurality of pulses. The controller may be for controlling the temporal spacing of the pulses based on a predetermined physical property of the target material. The beam delivery system may be for delivering and focusing at least one amplified pulse onto the target material, the at least one output pulse having a pulse duration in the range of about 10 picoseconds to less than 1 nanosecond. The pulse duration may be within a thermal processing range. The at least one focused output pulse generally having sufficient power density at a location within the target material to reduce the reflectivity of the target material and efficiently couple the focused output into the target material to remove the target material.

The system controller may further include a delay line.

The predetermined physical property includes a differential thermal property.

The system predetermined physical property includes dissipation of vapor plasma plume.

The amplifier may be a fiberoptic amplifier.

At least one of the first and second lasers may be a diode pumped fiber laser oscillator.

At least one of the first and second lasers may be a semiconductor laser diode.

The temporal spacing may have a range of about 2 nanoseconds to 10 nanoseconds.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

These and other features, aspects, and advantages of the present invention will become better understood with regard to the following description, appended claims, and accompanying drawings where:

FIG. 1a is a block diagram showing a portion of a laser processing system for link removal using at least one pulse in at least one embodiment of the present invention;

FIG. 1b shows a block diagram of a portion of the external modulator sub-system of FIG. 1a wherein a portion of an amplified pulse train is controllably selected for “on-the-fly” processing of links;

FIG. 1c is a top schematic view (not to scale), of a target link in a row of links showing, by way of example, focused laser output on a target link structure during motion of the link relative to a laser beam;

FIGS. 2(a-b) are block diagrams showing some elements of alternative solid state laser sub-systems, each having a master oscillator and power amplifier (MOPA), which may be included in at least one embodiment of the present invention;

FIG. 3 is a schematic diagram showing one arrangement for combining laser pulses or generating a sequence of closely spaced pulses using multiple lasers with delayed triggering;

FIG. 4 is a plot showing an example simulation results of exploiting differential thermal properties of a link and the underlying substrate to remove the link without damaging the substrate by applying two pulses having a pre-determined delay;

FIG. 5a is a graph illustrating, by way of example, a relationship between a heat affected zone (HAZ), spot size, and a link pitch;

FIG. 5b illustrates, by way of example, material removal with nanosecond pulses;

FIG. 5c is a graph illustrating, by way of example, dependence of fluence threshold on laser pulse width and shows exemplary pulse width ranges and exemplary pulse parameters corresponding to embodiments of the present invention;

FIG. 5d is a graph illustrating, by way of example, the dependence of the absorption coefficient of Silicon on wavelength and shows exemplary laser wavelengths corresponding to embodiments of the present invention;

FIG. 6a is a block diagram showing elements of a laser sub-system wherein a seed laser of FIG. 2a or 2b is a diode pumped, solid state laser oscillator and a diode pumped, solid state laser amplifier is used to amplify the output of the seed laser;

FIG. 6b is a block diagram showing elements of a laser sub-system wherein a seed laser of FIG. 2a or 2b may be a picosecond laser diode or microchip laser for producing picosecond pulses, for example;

FIGS. 7(a-c) are block diagrams showing additional design alternatives which may be used in an embodiment of the present invention, including configurations for at least one of amplification, wavelength shifting, and “down counting”/“pulse picking”;

FIGS. 8(a-c) are schematic diagrams showing details of exemplary master oscillator power amplifier (MOPA) configurations which may be used in at least one embodiment of the present invention, wherein a seed laser is amplified with at least one fiber optic amplifier to produce picosecond pulses and including at least one modulator for selecting pulses; and

FIG. 9 is a block diagram of a laser based memory repair system, including a picosecond laser system, and further showing an example implementation of the present invention.

### DETAILED DESCRIPTION OF PREFERRED EMBODIMENT(S)

Overview—Laser System Architecture

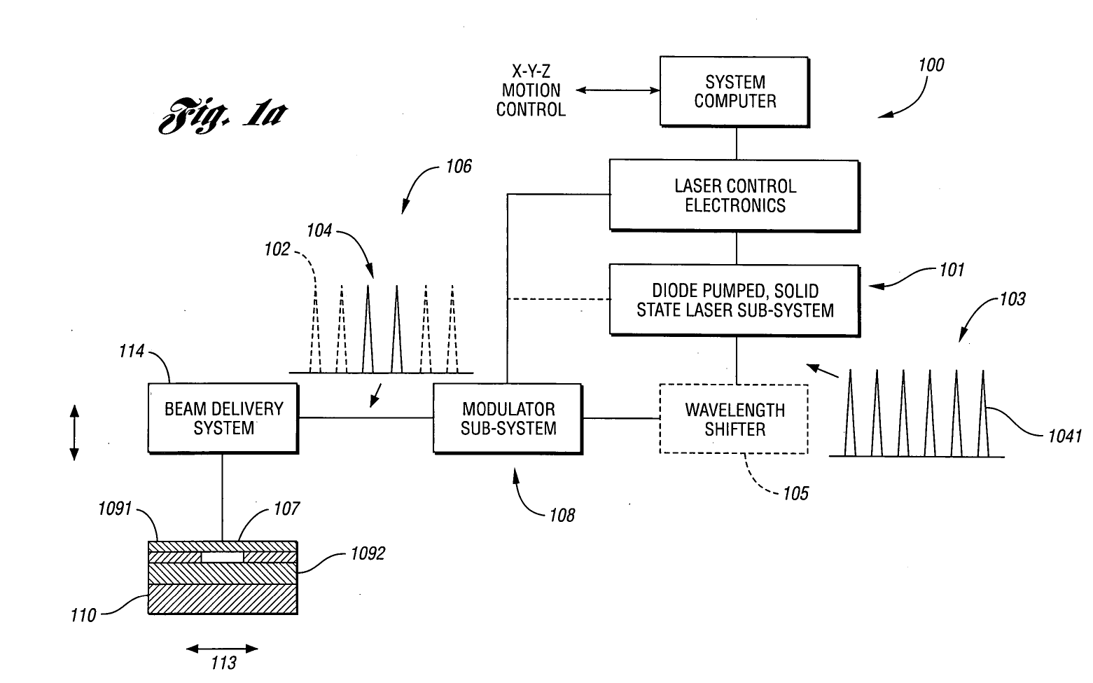

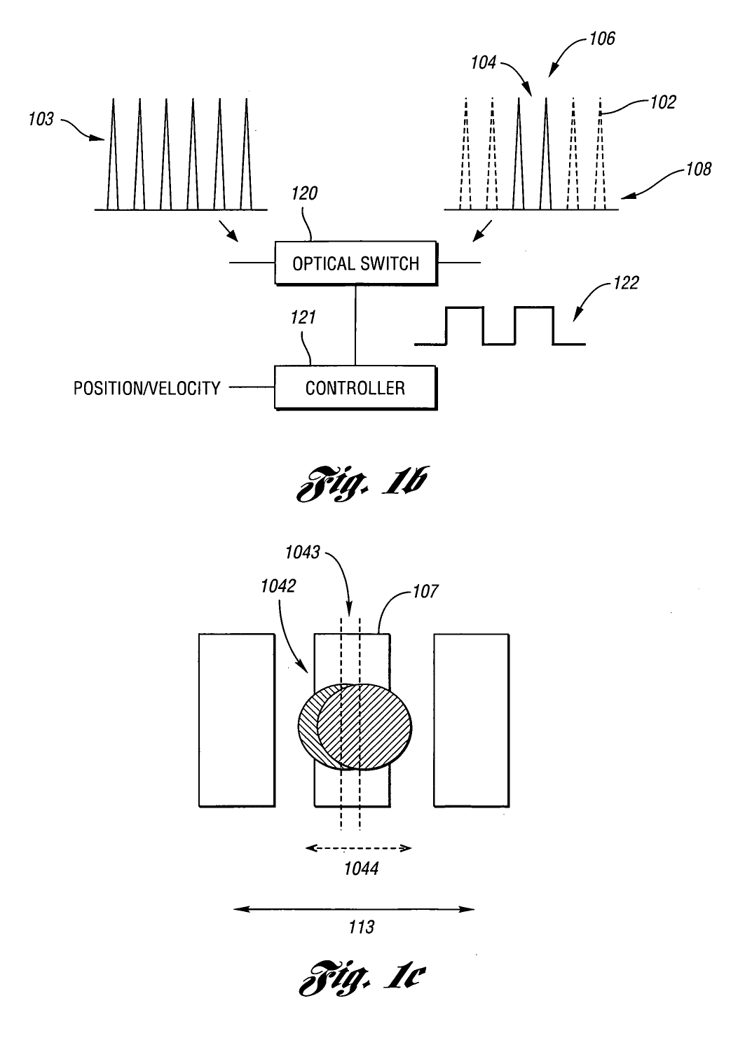

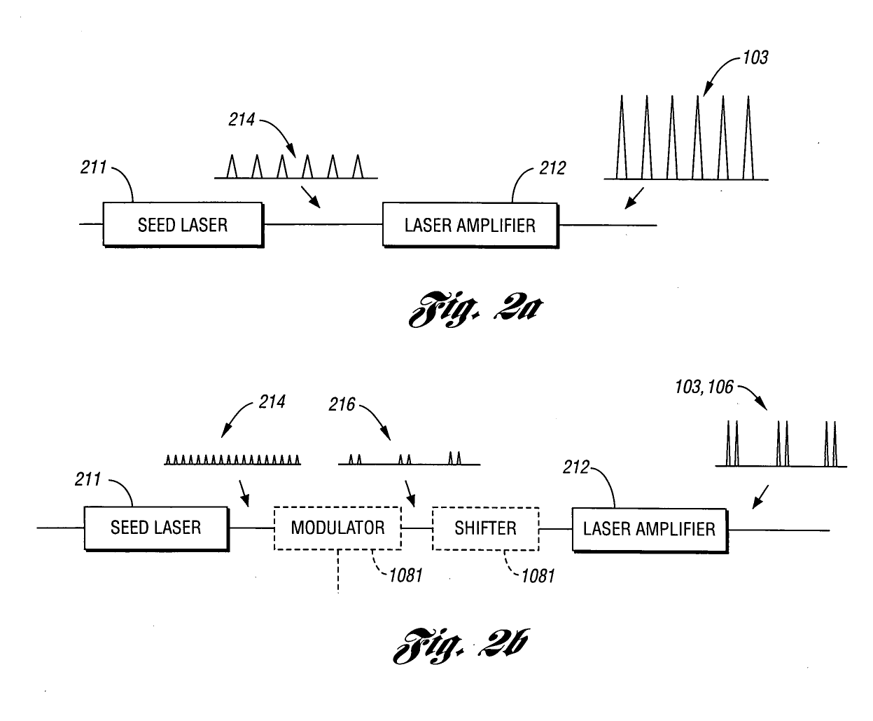

Referring to FIG. 1a, a block diagram illustrating a portion of a laser processing system 100 for removal of an electrically conductive link 107 using at least one output pulse 104 having a picosecond pulse width (i.e., pulse duration, etc.) 1041 (e.g., as measured at the half power point) and shows some major system components included in at least one embodiment of the present invention is shown. At least one embodiment of the invention may include a diode pumped, solid state laser in sub-system 101 to produce intermediate pulses 103 having pulse widths 1041 in a preferred picosecond range. The laser may be a commercially available diode pumped, solid state (active or passive) mode locked laser, for instance. For operation at a preferred wavelength the output 103 of the system 101 may be shifted in wavelength by optional shifter 105 (e.g., a harmonic generator) for example from a near infrared wavelength to a visible or near UV wavelength.

A single pulse, or plurality of pulses may be selected and delivered to a link 107, and the delivered pulses may have a pre-determined pulse width and time interval between pulses (“temporal spacing”) based on a physical property of at least one of the link 107, substrate 110, upper dielectric layer 1091, and lower dielectric layer 1092. The beam delivery system may include polarization control, relay optics, beam expansion, zoom optics, and an objective lens for producing a nearly diffraction limited spot at link 107. Optional external modulator sub-system 108 may be operated under computer control to provide pulses on demand and vary the power of the pulses. By way of example, pulses 102 within the group of pulses 106 may be omitted (as depicted by the dashed lines). U.S. Pat. Nos. 5,998,759 and 6,281,471 (e.g., col. 12, line 63-col. 14, line 33 and the associated drawings of the '471 patent) teach the use of a modulator to provide a pulse to irradiate a link on demand during relative motion of the link and laser beam in a laser processing system.

Referring to FIG. 1b, a block diagram of a portion of the external modulator sub-system 108 of FIG. 1a is shown, wherein a portion of a pulse train 103 is controllably selected for processing of links during relative motion between substrate 110 and the laser beam (“on the fly”). The motion may be in three dimensions: X motion 113, Y motion (not shown) of substrate 110 which is generally mounted on a wafer stage, and Z axis motion of at least one optical element 114 within the beam delivery system. Reference is made to U.S. Pat. Nos. 6,114,118 and 6,483,071 assigned to the assignee of the present invention for precision positioning methods and systems for positioning of the wafer and the laser beam waist relative to a link position. Controller 121 generally produces control signals 122 based on position information, velocity information, or both position and velocity information relating a link position to a laser beam position. Control signals 122 generally gate (i.e., control) an optical switch 120. The optical switch 120 generally provides output pulses 106 which are a portion of the input pulse train 103. Hence, the generated pulses 103 may have a controlled output repetition rate and temporal spacing when the modulator (e.g., the modulator 108) is used to select the at least one output pulse 104 that irradiates one or more links (or other microscope structure). At least one optical element 114 within the beam delivery system may be used to precisely position the beam waist at high speed and to further optimize the delivery of the focused output pulses.

Referring FIG. 1c, exemplary pulsed laser output on target link 107 includes two focused laser pulses 1042, each having an identical spot size, corresponding to selected pulses 104. The distance 1043 corresponds to the temporal spacing between the pulses during relative motion 113. If distance 1043 is a relatively small fraction of the link width, for instance less than 25%, the fraction of energy enclosed in the link will approximate perfect spot positioning. Distance (or displacement) 1044 generally represents an effective dimension of the laser output, which equals the laser spot size for perfect placement. As the temporal pulse spacing increases, the speed of relative motion increases, or with finer link pitch (center to center spacing) 1043 is to receive increasing consideration.

Published U.S. patent application Ser. No. 2002/0,167,581, assigned to the assignee of the present invention and incorporated by reference herein, describes various methods and sub-systems to direct laser pulses to one or more links. The optical sub-systems or variants, which generally include a high speed, single axis deflector, may be incorporated within the beam delivery system of FIG. 1a as required. Specific reference is made to FIGS. 19 and 20 of '581 and the corresponding sections of the description for further information of the '581 disclosure. Further, the focused output may include a plurality of spots having at least one non-identical spot distribution or power density. For instance, FIG. 17 of the disclosure illustrates a focused pulse used as a “cleaning beam”.

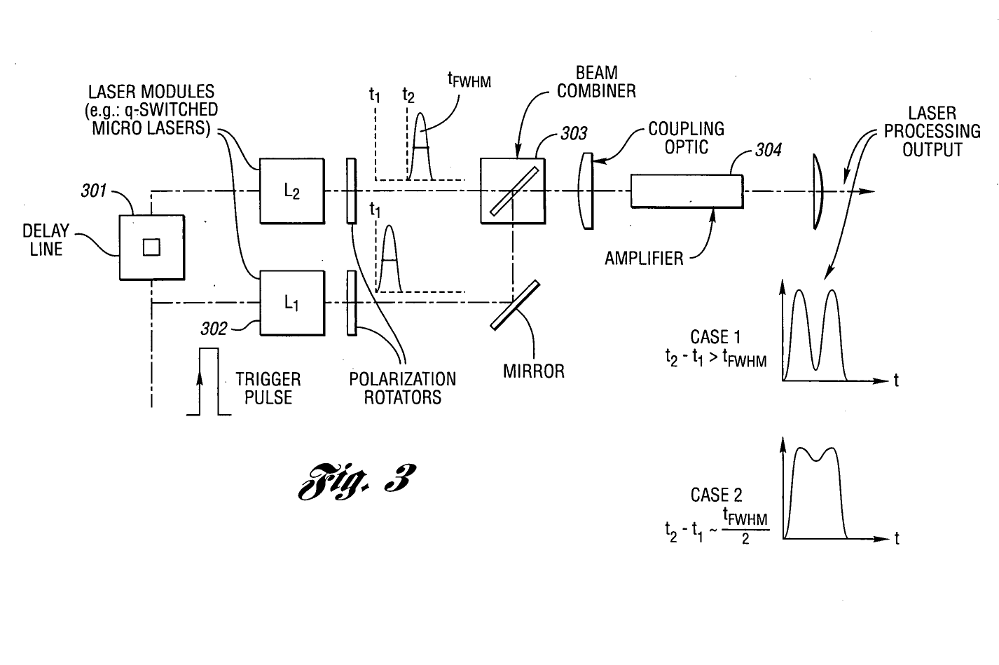

Referring to FIG. 2a, a block diagram of additional details of one alternative solid state laser sub-system which may be included in an embodiment of the present invention is shown. A seed laser (e.g., oscillator 211) produces a pulse train 214, the pulses generally having sufficient energy suitable for amplification with laser amplifier 212. The seed laser may be “free running” at a predetermined rate or “gain switched” to produce pulses under computer control. At least a portion of the pulse train is amplified to obtain the necessary laser pulse energy to sever a memory redundancy link, for instance to an energy level wherein the link is severed (e.g., removed) with a single pulse. One practical consideration for stable and reliable operation of pulsed laser amplifiers is operation within the rated average power. The operational considerations lead to an engineering tradeoff between the energy of a given pulse, the number of pulses, and the repetition rate.

In one alternative arrangement, shown in FIG. 2b (not to scale), a portion of pulse train 214 may be controllably selected with a suitable modulator arrangement 1081 (similar or identical to 108 of FIG. 1a) for processing of links during relative motion between substrate 110 and the laser beam (“on the fly”), however prior to amplification 212 of the pulse train to an energy level for link processing. A “down counting,” “divide down,” or “pulse picking” operation may be used to match a repetition rate of laser amplifier 212, which may be orders of magnitude below the repetition rate of the seed laser 211. For example, if R is the repetition rate of pulse train 214, then R/n will be the repetition rate at the output of the modulator 1081 when every n'th pulse is selected. If 214 represents a 50 MHZ pulse train, the output of the modulator will be 50 kHz when n=1000. In at least one embodiment, the pulse train repetition rate may be divided by a non-integer (e.g., 19.98) and varied over a relatively small range to synchronize the selected pulses with the position of the link, thereby compensating for motion system variations. Such an operation may be performed by controller 121 in either or both 108, 1081, and may be based on position and/or velocity information.

In at least one embodiment of the present invention, a plurality of closely pulses may be selected. By way of example, output 103, 106 of laser amplifier 212 shows three pairs of consecutive amplified pulses selected from pulse train 214, a given pair which may then be selectively applied to link 107, while providing a reduced input repetition rate and low average input power for amplifier 212. If 214 represents a 100 MHZ pulse train, the spacing between the consecutive output pulses of a pair will be 10 nanoseconds. Throughput and repetition rate are generally related. Preferably the amplifier output repetition rate will be sufficient to provide rapid link processing rates and “pulse on demand” capability, while limiting the complexity of system position and/or velocity control. Preferably, the three exemplary pairs at 103,106 at the amplifier output may be applied to as many as three consecutive links during relative motion 113 of the link and laser beam. External modulator 108 may be used to block the laser energy from links which are not to be processed.

Likewise, dependent upon the spectral response of the amplifier 212, optional wavelength shifter 1051 may be used to match the wavelength of the seed laser 211 to a favorable (or compatible) wavelength range of amplifier 212. Modulator sub-system 1081 and the wavelength shifter 1051 may be used alone or in combination with sub-system 108 for controlling the final pulse temporal spacing and energy level as appropriate, depending upon specific design criteria of a particular application.

Referring to FIG. 3, yet another alternative arrangement for combining laser pulses or generating a sequence of closely spaced pulses using multiple lasers with delayed triggering is shown. A pre-determined delay (e.g., t₁ to t₂) between trigger pulses may determine the time interval for application of a plurality of pulses. The combined output may provide seed pulses for an optical amplifier. For example, two or more pulses (or groups of pulses) may be used to sever link 107. The arrangement may be used to provide fine control of the temporal pulse spacing (e.g., 2-10 nanoseconds for a pulse pair, 100-500 MHZ effective rate or “burst rate”).

As disclosed in U.S. patent application Publication No. 2002/0167581 ('581), incorporated by reference herein and assigned to the assignee of the present invention, the laser system may include a programmable digital delay line 301 for controlling the pulse temporal spacing t2-t1, lasers 302, a polarizing cube 303 for beam combining, and optional amplifier 304 to raise the energy level as required. By way of example, specific reference is made to paragraphs 120-122, 194-197, and the claims of '581 for additional details.

A laser wavelength within sub-system 101 will generally be in a range of about 0.150 microns to 1.3-1.55 microns, the latter range corresponding to diode laser wavelengths used in high speed telecommunications. In one example, the laser wavelength may be frequency multiplied (e.g., tripled) or Raman shifted with shifter 105 to a near IR, visible, or UV wavelength.

Laser Parameters and Link Removal

With a trend of decreasing link pitch and dimensions (i.e., fine pitch links), at least three parameters need to be jointly considered for removing a link 107 without damaging either the substrate 110 or adjacent links (not shown) which may not require processing: (a) the laser beam size on the target and its focal depth; (b) the beam positioning accuracy (e.g., the laser beam waist position relative to the link in three dimensions—during controlled X-Y motion and Z-axis motion of the at least one element 114, for example); and (c) the heat affected zone (HAZ).

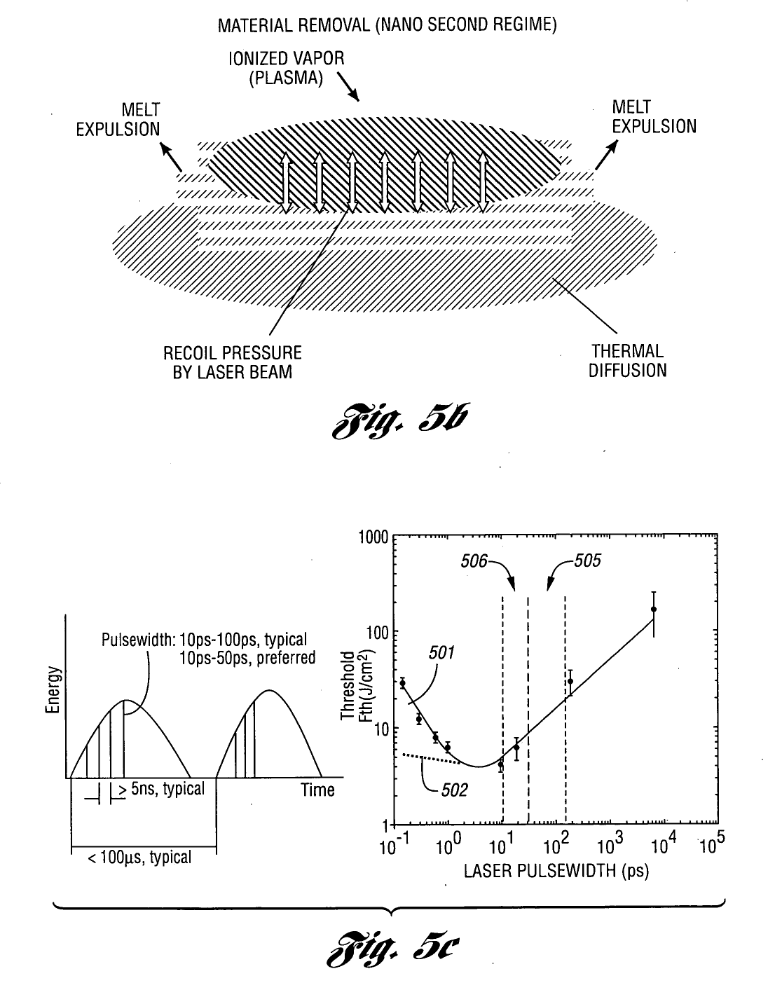

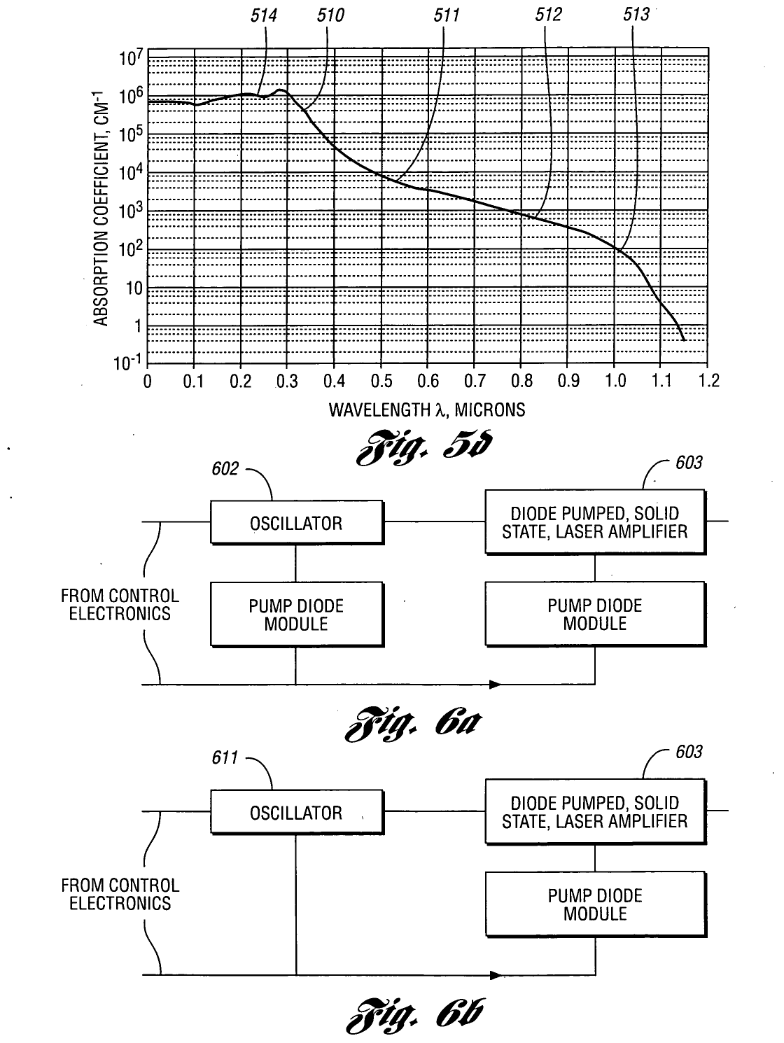

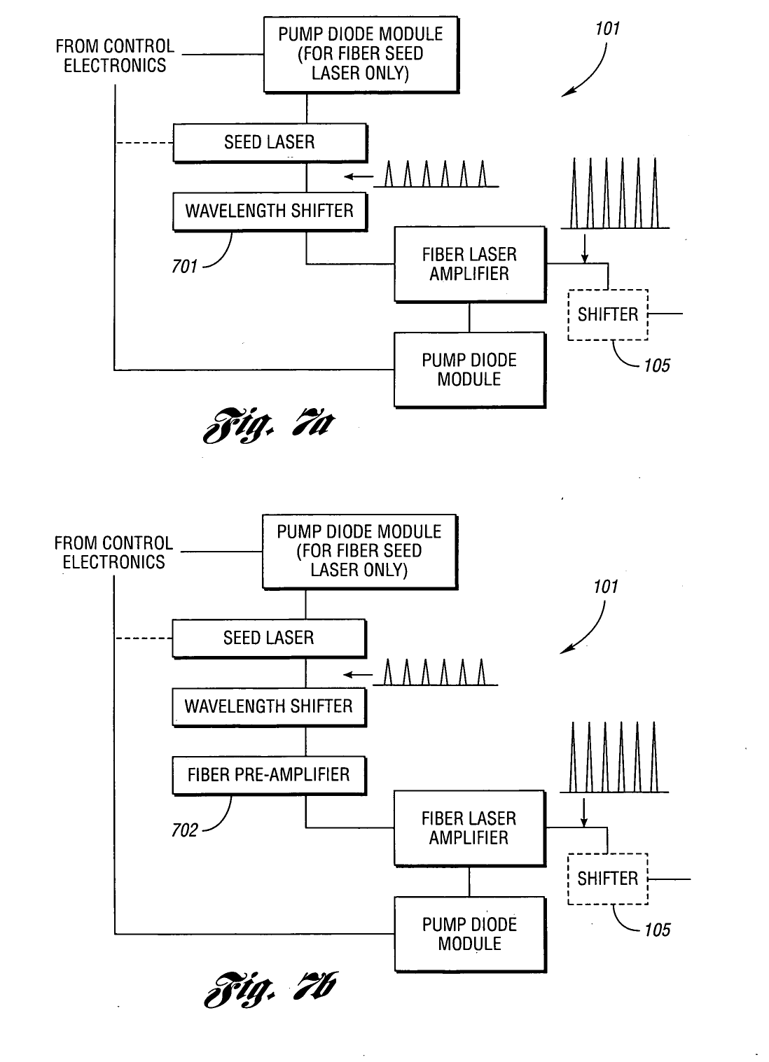

Refer to FIG. 5a with link pitch 521 in the range of 3-5 microns, the theoretical minimum pitch follows the formula:

Minimum Pitch=Beam Radius+Positioning Error+0.5 Link Width (1)

where the thermal effect by the laser beam is considered negligible.

For example, the GSI Lumonics Model M430 Memory Repair System, manufactured by the assignee of the present invention, provides a typical spot size of about 1.6 microns, and positioning error of about ±0.2 microns. The typical pulse width is about 4-10 nanoseconds and corresponds to a heat affected zone of about 0.85-1.4 microns.

The model M430 system is capable of processing links with minimum pitches of about 2 microns (assuming a link width of about 0.5 microns).

However, as the pitch approaches the dimension that is comparable to the thermal diffusion length, thermal effects within the region of link 107 may have increasing significance. The formula then becomes:

Minimum Pitch=Beam Radius+Positioning Error+0.5 Link Width+HAZ (2)

where HAZ (Heat Affected Zone) 522 is a measure of the thermal effect. The heat-affected zone (HAZ) is generally determined by (D * t)^{0.5}, where D is thermal diffusion coefficient and the laser pulse width. The actual value for the depth to which material is molten or vaporized depends also on the actual energy and power density on the target.

The HAZ may extend beyond the focused spot 523 and adversely affect peripheral areas adjacent to the spot. In some cases, the peripheral area affected may be several times greater than the spot itself. The relative large HAZ generally makes the laser process less controllable and less precise. In the case of link blowing, relatively large HAZ size may also be one of the limiting factors to the upper limit of the process window (neighboring links damage).

A diffraction limited spot and a short laser wavelength (e.g., 0.355 microns) may mitigate the problem to some degree, provided the spot is properly positioned relative to the link. However, if the positioning tolerance 524 of the system (including the X, Y, Z motion sub-system) is ±0.1 microns (a somewhat stringent requirement for high speed link processing), a spot size of about 0.58 microns may be needed to deliver the laser beam to a 0.38 micron wide link. Assuming a wavelength of 0.355 microns, and a 10 nanosecond (ns) pulse width, the estimated HAZ is about 1.3 microns. As such, a practical limit for processing links may correspond to about 1.9 micron pitch. Hence, a shorter pulse width is generally desirable.

Reducing the pulse width also generally reduces the HAZ. However, when thermal effect becomes very small compared to beam size and position error, further reducing the thermal effect before improving other significant contributors (e.g., beam size and positioning) may become unnecessary. The reduction in thermal effect from the nanosecond range to the picosecond range may be sufficient to process the finer pitch links. Further reduce the pulse width down to femtosecond range to eliminate undesirable thermal effects may be avoided for processes to remove (i.e., sever, “blow,” ablate, etc.) fine pitch links.

In accordance with the present invention, a limited thermal interaction generally occurs within a heat affected zone that is substantially less than cumulative tolerance of a link pitch and a relative position of the laser output relative to the target structure. For instance, a heat affected zone (HAZ) diameter of about 0.3 microns to about 1 micron will generally provide for improved processing of link pitch of 2 microns or less. Preferably, a HAZ will be less than the positioning tolerance of the laser output in three dimensions (e.g., less than 0.1 microns in each direction, and generally is considered negligible).

U.S. Pat. No. 6,281,471, incorporated by reference herein, elaborates on the rationale for the use of a short, fast rise time pulse. Specifically, col. 4, line 45-col. 5, line 19 elaborates on the effects decreasing reflectivity to improve coupling to target material. If the irradiance on a metal target structure (e.g., aluminum) is greater than about 10⁹ W/cm², the reflectivity of the target structure is reduced and coupling of the laser energy is improved. Thermal diffusivity (related to HAZ) generally varies as the square root of pulse width. A short laser pulse generally reduces or prevents heat dissipating to the substrate below the melting link and also heat conducting laterally to the material contiguous to the link.

As the link pitch becomes finer thermal interaction with nanosecond pulses may be increasingly chaotic, resulting in poor precision for link removal. As illustrated in FIG. 5b, a relatively large volume of material may be heated and melted, and material removal occurs through melt expulsion driven by vapor pressure and the recoil of laser radiation pressure. At a fine scale the shape and volume of removed material may be irregular and include a non-acceptable large statistical variation. With picosecond high peak power pulses the interaction may become non-linear, initially with avalanche ionization where the reflectivity is reduced as a result of the high free electron density in metals, with decreased statistical variation. With such short pulses the laser energy is generally confined to a thin layer and vaporization generally occurs rapidly. Material removal generally becomes more precise and deterministic, with reduced laser fluence to initiate ablation. Material removal with picosecond pulses may further include removal of heat from the laser processing region by material ejection (solid and vapor). The link removal process at the picosecond scale, for instance with the presence of an overlying dielectric layer 1091 and inner layer 1092, may be a mixture of removal with ablation and thermo-mechanical stress. Removal of the target link structure is generally assisted by heat removal from a link processing region by material ejection at the pulse width and power density.

By way of example, FIG. 5c shows variation in fluence threshold for two exemplary dielectric materials (e.g., see U.S. Pat. No. 5,656,186 and the publication Du et al., “Laser-Induced Breakdown by Impact Ionization in SiO₂ with pulse widths from 7 ns to 150 fs,” APPLIED PHYS., Lett., 64 (23), 6 Jun. 1994, pp. 3071-3073. As is well known, the fluence threshold is generally much lower for metals (e.g., ten times or more) as a result of the higher free electron density. Below the breakdown point the threshold 501, 502 varies with material but the statistical variation (shown by error bars) is generally relatively small. In the illustrated example (provided with the published data in the publication), 501 varies as 1/(pulsewidth) whereas 502 is taken as approximately constant (as illustrated in the '186 patent). Above the breakdown point, an approximate square root relation holds, but increasing variation with pulse width is apparent, particularly at the nanosecond scale.

A characteristic pulse width of the break down point of metals, may typically be about 10 ps (e.g., see U.S. Pat. No. 5,656,186). In accordance with the present invention, the typical laser pulse width is less than 1 nanosecond, and most preferably much closer to the characteristic pulse width of the breakdown point so that detrimental thermal effects are negligible (e.g., the present invention produces reduced HAZ and statistical variation). However, the link removal process of the present invention is generally a thermal process. The interaction between the laser pulse and the material is mainly a thermal (though greatly reduced) process since the laser pulse width is longer than that of the breakdown point, and preferably close to the breakdown point.

The present invention will generally provide an efficient link removal process rather than a slow etching process defined by the optical absorption depth, which is only on the order of a few nanometers per pulse for most of metals. Since the breakdown point is material dependent, the lower end of the pulse width is therefore also material dependent. A minimum pulse preferred pulse width may be in the range of a few picoseconds (ps) to about 10 ps. A maximum pulse width is generally less than about 1 nanosecond (ns) and will generally determined by the heat affected zone allowable. Generally a pulse width of the present invention will in the range from above the breakdown point to less than 1 ns. A pulse width may be in the range 505 of about 10-100 ps, for example 40-100 ps. A most preferred pulse width is in the range 506 of about 10 ps to about 40 ps, or about 10 ps to about 50 ps.

The laser systems which produce picosecond pulses are typically simpler, more reliable and stable, and more cost effective as compared to femtosecond lasers. A significant difference is implementation of pulse compression for femtosecond generation of high peak power pulses.

Numerous references further elaborate on interaction in the femtosecond-picosecond pulse range. For example, Chichkov et al., “Femtosecond, Picosecond, and Nanosecond Laser Ablation of Solids,” APPLIED PHYSICS, A 63, 109-115, 1196 provides theoretical background and experimental results. Femtosecond pulses were found to have thermal conduction into a target that can be neglected to a good approximation, and the process regarded as a direct transition form solid to vapor, resulting in precise laser processing. The ablation depth has a logarithmic dependence on laser pulse fluence. With picosecond pulses, ablation is accompanied with heat conduction and formation of a melted zone within the target, for instance a metal. When heat conduction into the target is neglected, (which may be a rather crude assumption), then the logarithmic dependence of the ablation depth on fluence is also generally possible with picosecond pulses. However, processing in the nanosecond range has been generally regarded as much more complicated as a result of thermal wave propagation and formation of a large layer of melted material.

Jandeleit et al., “Picosecond Laser Ablation of Thin Copper Films,” APPLIED PHYSICS A, 63, 117-121, 1996, disclosed results of ablation experiments wherein holes were drilled in thin copper films on fused silica using picosecond pulses. Although high intensity picosecond pulses having pulse widths greater than the characteristic pulse width of the breakdown point generally follow the square root relationship, the reduced heat affected zone and lower heat load provide rapid heating and removal of target material when compared to nanosecond and longer pulses. An intensity of about 10¹⁰-10¹¹ W/cm² over about a 3.1 um diameter spot removed (on the average) about 0.1-0.2 μm of material per each 40 ps pulse at a wavelength of 1.053 microns. Comparison of the results with the known optical absorption depth of copper at 1.053 microns indicated that heat conduction generally determines the ablation depth. The pulse-pulse variation in the material removed may be significant (e.g., 2:1). However, the HAZ was relatively small and collateral damage minimal.

Hence, the benefit of a pulse width from about 10-25 ps down to below the breakdown point (typically less than 10 ps) is generally not so significant as compared to benefits provided by the beam spot size reduction and positioning error improvement for the overall system capability. In addition, the cost of femtosecond laser sources is typically much more than the cost of picosecond laser systems, particularly fiber laser based picosecond laser systems.

Link processing includes removal of a target structure, typically a metal thin film. The link is typically surrounded by materials (e.g., passivation layers 1091,1092, substrate 110) having dissimilar thermal and optical properties. As such, some multi-material interaction mechanisms may be somewhat complex compared to material processing interaction with a homogeneous “bulk” material. At least one dimension (e.g., link width) is typically on the order of a wavelength of visible or UV light. Also, with finer link pitch technology that is emerging, the fraction of the spot energy that enclosed within the link dimension needs careful consideration by a designer of link processing equipment. In at least one embodiments the laser wavelength is less than one micron, for example, 0.90 microns or less, to achieve a smaller spot size on the link in connection with the reduced pulse width.

Since the smallest spot size is generally proportional to the wavelength, any reduction in wavelength will be beneficial to the reduction of the smallest spot size achievable. In addition, the depth of focus will generally be larger for the same spot size at such shorter wavelengths. For example, for a 1064 nm laser, the diffraction limited spot size is approximately (i.e., substantially, nearly, about, essentially) 1.2 microns (diffraction limited spot size=(constant) *wavelength*f number of the lens). When the wavelength is reduced to 0.8 microns, the diffraction limited spot size will be reduced by 20% accordingly as well, i.e., to approximately 0.9 microns. Generally, for fine pitch processing a spot size of less than about 1.5 microns is preferred, and most preferably 1 micron or less. In at least one embodiment of the present invention, a non-round spot profile (e.g., an elliptical spot produced with an anamorphic optical sub-system) may be used (see, U.S. patent application Ser. No. 2002/0,167,581, for example). In particular, paragraphs 133-136 illustrate how a non-round spot may improve energy enclosure within a link in at least one embodiment.

Material variations (e.g., variations, whether by design, by process defect, or as a process by-product) may be encountered and are generally expected to further affect the process energy window as the pitch is decreased. The link may be a metal (e.g., Al, Cu, Au, etc.), polysilicon, or a refractory metal. At least one layer of Silicon Nitride (Si₃N₄) 1091 may cover the link, and a layer of Silicon Dioxide (SiO₂) 1092 may separate the substrate 110 and link 107. However, in some cases the link may not be covered with an outer layer. Additionally, the presence impurities, dopants within the substrate or dielectric layers, and next generation dielectrics (e.g., low-k polymeric materials) may each have a substantial effect on the optical properties of the materials. In a wavelength range wherein the wavelength is greater than the absorption edge of the dielectrics 1091,1092 and less than the absorption edge of the substrate 110 substrate damage may easily occur with long laser pulses.

Link 107 may be substantially reflective at the laser wavelength. In accordance with the present invention, the laser output wavelength will generally be below the absorption edge of the substrate and hence correspond to an absorbing and/or reflecting wavelength region. The laser wavelength is typically above the absorption edge of the dielectric layers 1091,1092 which, in one example, may be inorganic, and will generally correspond to a substantially maximum transmitting region, for typical inorganic passivation layers (e.g., Si₃N₄, SiO₂, etc.) used with present semiconductor memories.

Referring to FIG. 5d, typical variation in the absorption coefficient (e.g., at room temperature) of Silicon, the absorption being very high at short wavelengths is shown. Doping (not shown) generally changes the absorption and shifts the near IR absorption edge to shorter wavelengths. Published European patent application EP 0 902 474, published 17 Mar. 1999, teaches shielding the substrate with one or more materials to avoid substrate damage. With such modifications a shorter wavelength laser (and a reduced spot size) provides for reduction of link pitch. The shielding materials may be metals, refractory metals, or dielectrics. Such modifications may also be used with the present invention to further enhance performance.

In accordance with the present invention, a laser wavelength may be in a range from below 0.4 μm to about 1.55 μm. Exemplary wavelengths may be in the UV range (e.g., 514, 212-266 nm), near UV (e.g., 510, 355 nm), visible (e.g., 511, about 500 nm, for instance 532 nm) and near IR spectrum (512, about 750-850 nm or 513, about 1 μm). It can be seen that Silicon absorption varies by about 1000:1 throughout the wavelength range. A preferred wavelength may be in the range of about 0.18 microns to about 0.55 microns. The lower limit may be determined by the absorption of a layer. With silicon substrates, both absorption and reflection increase at shorter wavelengths. Over the wavelength range of interest the Silicon semiconductor properties change dramatically from near IR dielectric-like properties to metal-like properties in the UV range. For Silicon Dioxide and Silicon Nitride, the internal transmission and single surface reflectance are substantially constant throughout the visible and near IR ranges. Spectral transmission curves for typical large bandgap dielectric materials generally show that the transmission decreases somewhat at UV wavelengths. For example, in HANDBOOK OF LASER SCIENCE AND TECHNOLOGY, the transmission range of Silicon Dioxide is specified as wavelengths greater than 0.18 μm. The absorption coefficient of both Silicon Nitride and Silicon Dioxide remains relatively low in the visible range (>400 nm) and gradually increases in the UV range.

If the predetermined wavelength is below an absorption edge of the substrate, the pulse energy density at the substrate may reduced and the process window may be increased by at least one of: (a) beam divergence (shallow depth of focus); (b) dielectric surface reflection; (c) beam diffraction; (d) multiple scattering (e.g., caused by dopants or impurities); (e) internal reflection (which may vary with the focused laser beam numerical aperture); (f) multi-layer interference; and (g) non-linear absorption within the microstructure (if the laser spot is properly positioned in three dimensions then at the leading edge of the high peak power laser pulse the free electron density in a metal increases the absorption, and link material removal may occur at a rate faster than that of the substrate. The substrate is irradiated with off-link energy (e.g., lower peak intensity) and has fewer free electrons than that of the link.

In order to process links less than 0.5 micron thick, for example, aluminum or copper links, the range of the peak energy density (Joules/cm²) is about 0.2 J/cm² to 300 J/cm², with a typical value in the range 2-80 J/cm². The range of peak power density is about 5×10⁹ W/cm² to 1.2×10¹³ W/cm², with a typical value in a range of 5×10¹⁰-2×10¹² W/cm². For a 40 ps pulse width laser with a spot size of 1 micron, the pulse energy range for severing links less than 0.5 micron thick is generally in a range of 0.001-3 micro joules with a typical value at a range of 0.02-1 micro joules.

Either a single pulse or multiple pulses may be used to remove the link. If a single pulse is used to remove the link the picoseconds laser system is to generally provide a range of about 1-5 micro joules per pulse at a 10 KHz-120 KHz repetition rate. An exemplary range is less than about 1 microjoule to a maximum of 2 microjoules. Preferably single pulse processing will be implemented with an oscillator/amplifier configuration, for instance the seeder/amplifier configuration as shown in FIG. 2a.

In one embodiment of the present invention, multiple pulses may be used to remove the link with a picosecond laser system providing at least 0.001 micro joules (1 nanojoule (nj)) per pulse at a repetition rate of at least 1 MHZ. The pulses applied to the link may be treated as a single pulse for link removal during relative motion in three-dimensions between the link and laser beam (e.g., 5-50 mm/sec along X-Y axes). In another embodiment of the present invention, about 15-20 pulses may be applied at a repetition rate of 10-100 MHZ , each with about one-tenth the energy required for removal with a single pulse, while traversing a fraction of a link.

Embodiments of the present invention may also include a plurality of closely spaced amplified pulses, for instance, two or more pulses each with about 50% of the energy that is generally required to remove a link with a single pulse. Pulses may be selected with control of modulator sub-system 1081 within the laser system 101, external modulator sub-system 108, or a combination thereof.

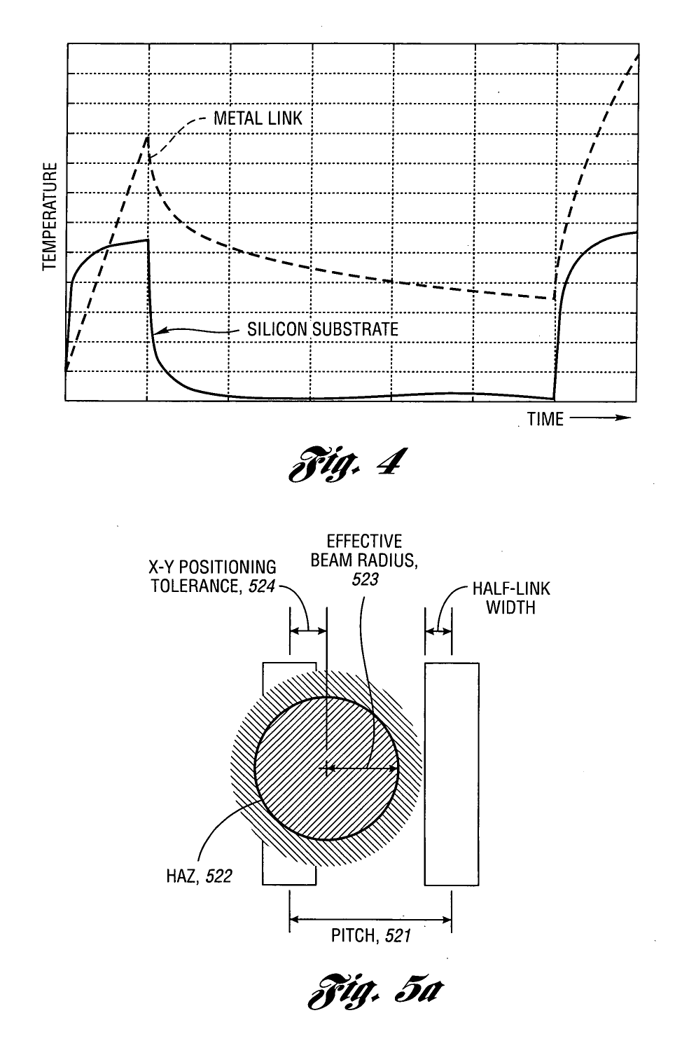

In a multiple pulse process, the temporal spacing between the pulses used to irradiate the link on demand may be selected based on a pre-determined physical property (e.g., differential thermal properties) of the link and surrounding materials. Referring to FIG. 4, simulation results which, by way of example, demonstrate an effect of exploiting differential thermal properties of a link and the underlying substrate to remove the link without damaging the substrate by applying two pulses having a pre-determined delay are shown. According to the simulation results obtained (in this case with nanosecond pulses having a square shape), “double blast” (e.g., two pulses) with 50% energy of a “single blast” energy was very interesting. The Silicon substrate generally acts as a heat sink and cools down very fast compared to the link. As shown in FIG. 5a, the results indicated the substrate 110 to stabilized to room temperature in only 10 to 20 ns. The link 107 (copper) recovery was much slower indicating a significant differential thermal property. Based on the results, the second pulse will generally also clear debris at cut site (i.e., link removal) resulting in an “open circuit”.

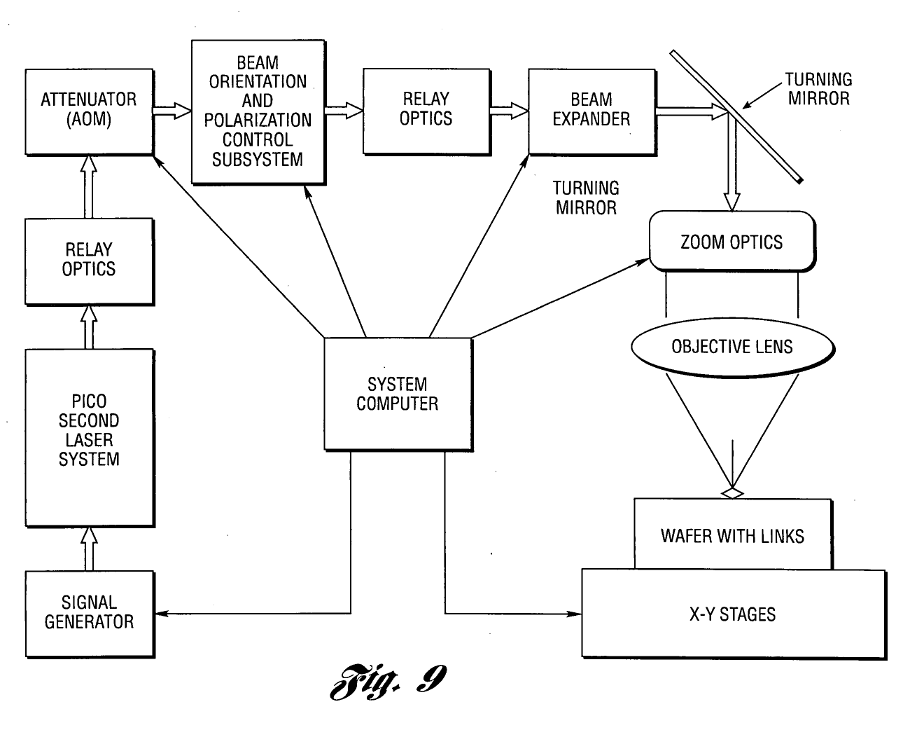

If, for example, a 60 MHZ mode locked system (e.g., picosecond pulses) is used, the spacing between consecutive pulses of the output pulse train may closely match the pre-determined spacing. If a larger temporal spacing is desired, a high speed modulator arrangement may be used to select any sequence of pulses or group of pulses, for example. A higher repetition rate may be used to decrease the pulse temporal spacing, or a second laser may be provided as shown in FIG. 3. For example, two pulses, each having a pulse width in the range of about 40 ps to 100 ps and spaced by 2-10 ns may be generated. By way of example, q-switched microlasers may be used to provide pulse widths of a few nanoseconds at a repetition rates of about 10 KHz-100 KHz. Further processing of the nanosecond pulses may occur (as will be shown, for example, the embodiment shown in FIG. 8b) wherein a high speed modulator is used to “slice” or compress the pulse to the picosecond scale, followed by amplification. Further details relating to temporal pulse shaping may be found in U.S. Pat. Nos. 6,281,471 and 4,483,005 (entitled “affecting pulse width”) assigned to the assignee of the present invention.

Other physical properties may be exploited. With the application ultrashort pulses to various materials, for instance in the range of 50 femtoseconds to a few picoseconds, the plasma shielding of the laser beam is generally negligible, as taught in several references (i.e., Zhu et al., “Influence of Laser Parameters and Material Properties on Micro-Drilling with Femtosecond Laser Pulses,” APPL. PHY. A 67 (Suppl.) 5367-5371 (1999). Though not as efficient as operating in the femtosecond range, picosecond pulses having preferred pulse widths near the breakdown point and somewhat longer (e.g., a range of 5% to 25% longer) than the breakdown point may provide for better coupling of laser energy than nanosecond pulses. For example, pulses may be in the range of about 10 ps to 100 ps, and most preferably in the range of about 10 ps to about 40 or in a range of about 10 ps to about 50 ps. The coupling of energy with longer pulses, for instance 10-30 nanoseconds, may be severely degraded as a result of ejected vapor/plasma/plume. Further, the incident beam may be scattered and produce substantial off-link energy which can reduce the process energy window.

Hence, though a series of picosecond pulses may be equivalent to a multiple nanosecond pulse for the purpose of “on-the-fly” removal, the overall interaction of the laser with the material and processing results may be significantly different when a plurality of pulses each with a temporal spacing of at least several nanoseconds between pulses is used. U.S. Pat. No. 6,552,301 discloses the use of a burst of ultrafast laser pulses, each of the pulses having a pulse width less than about 10 ps, and having a time separation between individual pulses to exploit the persistence of a selected transient effect arising from an interaction of a previous pulse with the target material. Further, “Laser Micromachining of Transparent Glasses and Aluminum with ps-pulse bursts at 1054 nm,” Herman, CLEO 2000, CDF3, (2000), disclosed that a 7.5 ns pulse separation mitigates plume absorption effects to some extent. A time interval may be pre-selected based on (at least) a time interval for substantial dissipation of plasma/vapor/plume after application of first a high peak power, picosecond pulse. An exemplary range is about 5 ns to several hundred nanoseconds. Additional pulses may subsequently be applied for efficient coupling.

Further, when picosecond pulses having high power density (e.g., of 10⁹-10¹³ W/cm²) are applied to the link, intensity dependent non-linear absorption, for instance within dielectric layer 1092 or other adjacent material, may attenuate incident energy after the link is removed and may reduce the possibly of substrate or collateral link damage. The presence of impurities (by design, or as a process defect or byproduct) lattice defects or various process defects may enhance non-linear absorption in one or more dielectric layers. Further, optical properties of some low-k dielectrics such as polymeric dielectrics may support controlled removal of material by non-linear absorption.

Pico Second Laser Embodiments

Solid state laser wavelengths may be 1.3, 1.18, 1.09, 1.064, 1.053, or 1.047, microns with Neodymium (Nd) doped solid state lasers (Nd:YAG, Nd:YLF, Nd:YVO4) or with other rare earth elements (e.g., ytterbium (Yb), neodymium (Nd), erbium (Er)) doped fiber lasers. Preferred laser wavelengths may also be the second, third, fourth, and fifth harmonics of these and other appropriate lasers to achieve small spot sizes and larger focal depths to meet the design criteria of a particular application. For example, laser sources with laser wavelengths in the UV (e.g., 355 nm from the third harmonic, 266 nm from the fourth harmonic, and 212 nm from the fifth harmonic), in the visible (e.g., 532 nm from the second harmonic), near IR wavelengths (e.g., 700-900 nm), which provide a spot size improvement relative to conventional wavelengths, may also be used. One such a laser system is a mode locked Ti:sapphire ultra fast laser (without a compressor) which produces laser pulses with pulse widths in pico-second range in the 750 to 850 nm range. Another is the rare earth element doped fiber laser that generates wavelength in a range of 800-980 nm.

Exemplary laser sub-systems which may be included in embodiments of the present invention will now be described in more detail. In one embodiment, corresponding to FIG. 1a, a commercially available diode pumped, passive or active mode locked system may be included. The external modulator system 108 may be implemented to deliver the selected pulses of 106 to link 107.

Another laser configuration which may be used in at least one embodiment of the present invention is shown in FIG. 2a. In a MOPA configuration a pico-second seed laser (e.g., oscillator producing an output in a range for amplification) and (power) amplifier system is used to obtain the pulse energy required.

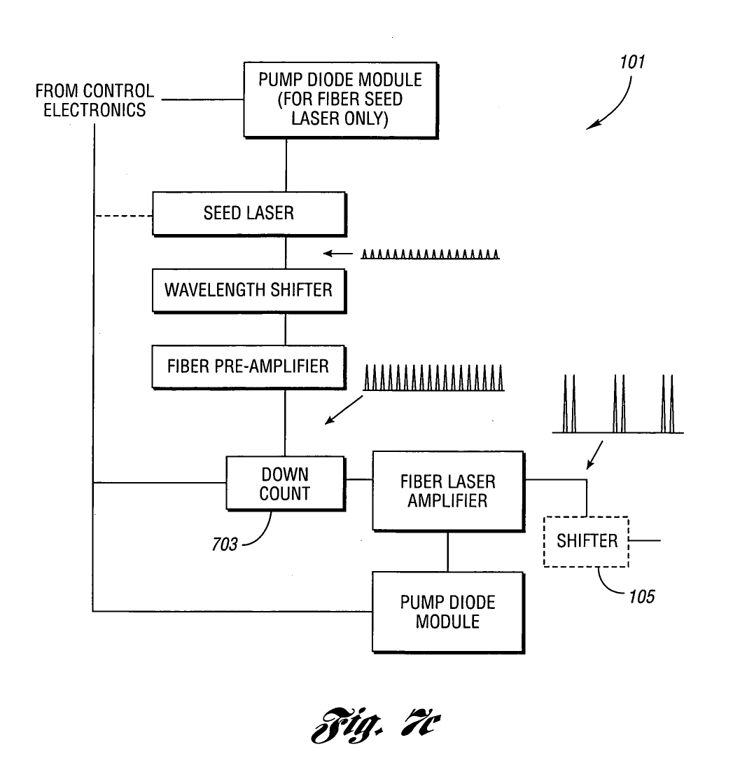

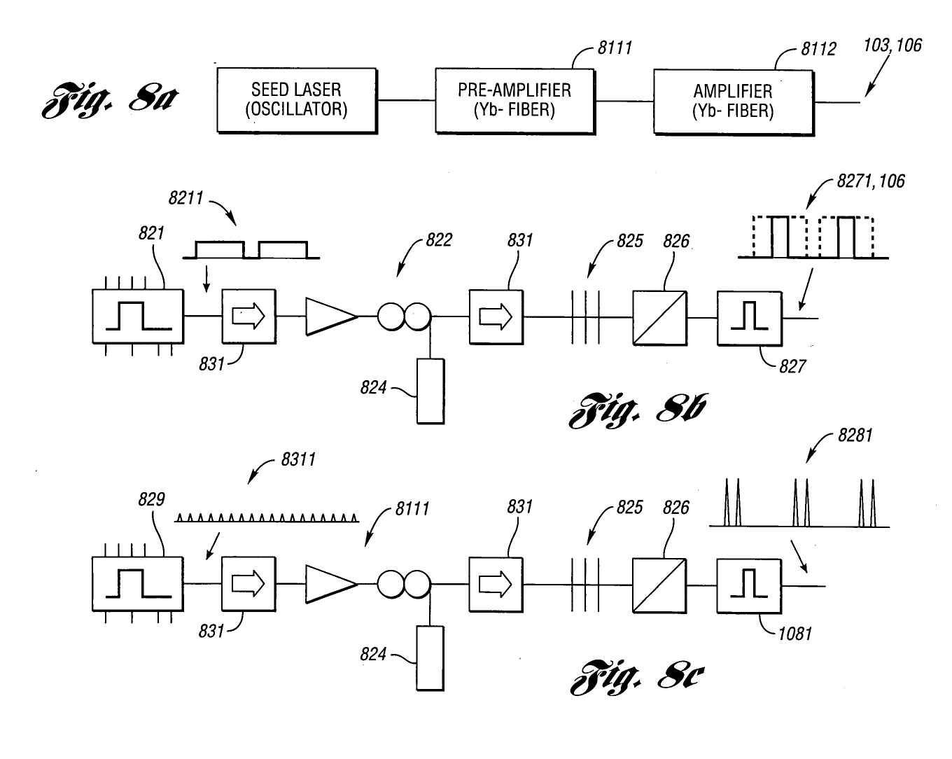

Referring to FIG. 6a, a block diagram illustrating additional details of a laser sub-system wherein the seed laser 211 of either FIG. 2a or FIG. 2b is a diode pumped, solid state laser oscillator 602 is shown. Diode pumped, solid state laser amplifier 603 may be used to amplify the output of the seed laser. Oscillator 602 may be a mode-locked, diode pumped solid state oscillator seed. External modulator sub-system 108 may be used to control the number of pulses on each link and the temporal spacing between the pulses. A mode-locked oscillator will generally operate at very high repetition rates (>1 MHZ) compared to conventional q-switched lasers. The laser system include may also include the modulator sub-system 1081 of FIG. 2b with control signals 202 (e.g., in a typical range of 20-150 KHz) to control the number of pulses on each target while processing links during motion of the link relative to the laser beam. In any case, the seed laser (e.g., which, if suitable, may be a packaged, commercially available laser source) may include an internal pre-amplifier to amplify the pulse energy to a suitable range for power amplification with power amplifier 603.

An alternative configuration may include a diode pumped, mode locked, picosecond fiber laser oscillator as a seed laser 602. An all fiber laser system may be constructed if the diode pumped, solid state amplifier 603 is a fiber optic amplifier.

Exemplary fiber configurations suitable for amplifying high power short pulses, particularly ultrashort pulses, are disclosed in U.S. Pat. Nos. 5,400,350, 5,701,319, and 5,818,630. Exemplary lasers include the Femtolite and Wattlite series offered by IMRA, the assignee of the '350, '319, and '630 patents. Pulses down to 0.1 ps duration with average power of 1 watt with an output wavelength in the range of 1.03-1.06 microns have been achieved with Yb-fiber amplified, Femtolite-based source. Other wavelengths, (e.g., 780 nm) and frequency multiplied (second harmonic) outputs of 1.03-1.06 micron lasers are also available from IMRA. Additional information is also available in U.S. Pat. No. 6,281,471 (assigned to the assignee of the present invention) and International Published Patent Application WO 98/92050.

Various other solid state laser amplifier configurations may be adapted for use in at least one embodiment of the present invention. Planar waveguide technology may be well suited for high peak power, short pulse amplification. U.S. patent Publications 2003/0161375, 2003/0160034, and 2003/0021324, assigned to the assignee of the present invention, and the associated references disclose several waveguide amplifier embodiments. The waveguide designs, though not as readily available as fiber amplifier technology, provide high peak power outputs, and good beam quality, without undesirable Raman shifting of the seed wavelength. Also, planar waveguide amplifiers may be well suited for femtosecond pulse amplifiers.

Referring to FIG. 6b, a block diagram illustrating additional details of an alternative laser sub-system wherein the seed laser of FIG. 2 is a picosecond laser diode 611 for producing picosecond pulses is shown. The diode seed laser may be directly modulated.

Alternatively, the diode laser may be used to produce nanosecond pulses which are further processed within the laser system to produce picosecond pulses (as will be shown in more detail, for example, in connection with FIG. 8b).

In yet another arrangement, the seed laser 611 may be an active or passive q-switched microchip laser. An example of a commercially available microlaser is the AOT-YVO-1Q available from Advanced Optical Technology. For example, AOT offers a pulsewidth of 2 nanoseconds available at a repetition rate of 20 KHz. Frequency doubled versions are also available (532 nm). Microchip lasers are also offered by JDS Uniphase. In either case, a modulator may be used to reduce the pulse width as shown in more detail, for example, in connection with FIG. 8b. A diode pumped, fiber laser amplifier 612 may used to amplify the output of the seed laser.

A preferred embodiment may include the diode laser as the seeder and a fiber laser amplifier to obtain picosecond laser pulses. Fiber laser systems may have the advantages of compactness, excellent beam quality and control, high system reliability, ease in thermal management, and maintenance-free operation. U.S. Pat. No. 6,281,471 and WO 98/92050 discloses numerous features of master oscillator—power amplifier (MOPA) wherein a diode seed laser is amplified with a fiber amplifier.

In at least one embodiment, the temporal spacing of a sequence of the pulses may be controlled by “gain switching” of a seed laser, for example, as taught in U.S. Pat. No. 6,281,471. High speed pulsed laser designs generally utilize q-switched, gain switched, or mode locked operation, alone or in combination. “Pulsed pump” (e.g., real time control of pump diode module of FIG. 6a) may be used provided output stability is acceptable. U.S. Pat. No. 5,812,569 discloses an exemplary method of stabilizing the output energy of a pulsed solid state laser.

The output of the laser sub-system 101 (and from amplifier 603) may be wavelength shifted by shifter 105. Wavelength shifters, including harmonic generation modules, or other wavelength shifters may be used to shift the wavelength to shorter or longer wavelength depending on the process requirement. Wavelength shifting or conversion techniques are well known and documented. Examples of the wavelength shifter include Raman shifter, frequency up conversion or down conversion, frequency doubling, etc. For example, Concept Design Inc. provides second, third, and fourth harmonic conversion of femtosecond Ti:Sapphire outputs (fundamental wavelength in the range of 750-850 nm) resulting in available wavelengths as short as about 215 nm. Additional products which include ultrafast frequency converters are offered by Coherent, Spectra Physics, and Lumera.

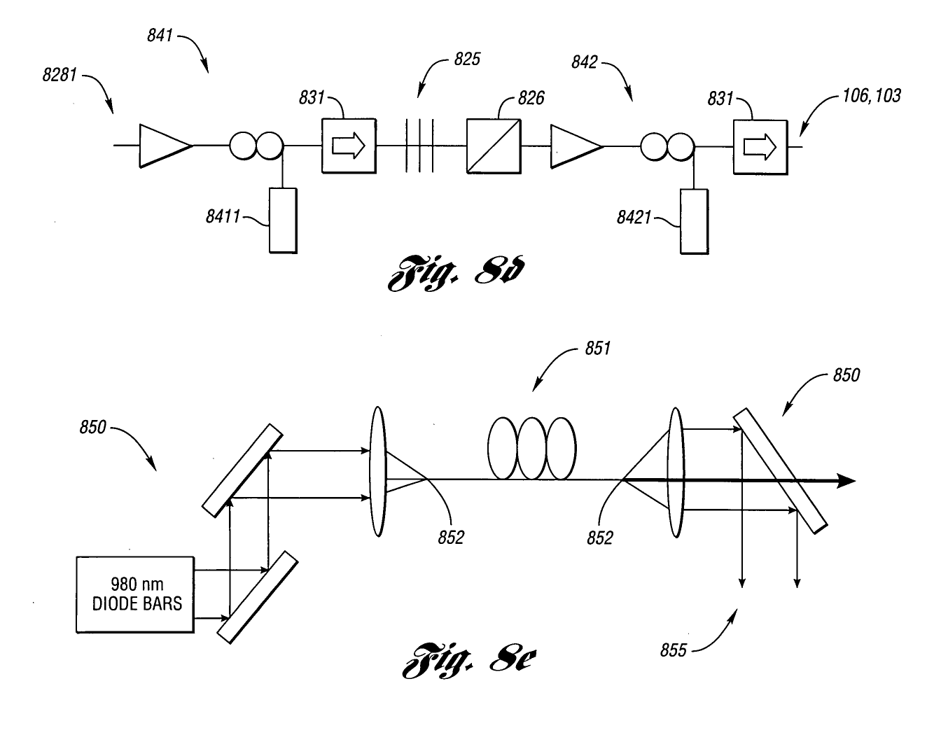

Referring to FIGS. 7(a-c), block diagrams illustrating various alternative configurations which may be used within laser sub-system 101 are shown. In FIG. 7a, a wavelength shifter 701 is disposed between the seed laser and the amplifier. In this case, the seed laser wavelength is not the same as that of the power amplifier. Hence, wavelength shifting is implemented to shift the output wavelength from the seed laser to a wavelength within the range of the power amplifier. Examples of the wavelength shifter include Raman shifter, frequency up conversion or down conversion, frequency doubling, etc.

FIG. 7b illustrates yet another configuration wherein a pre-amplifier 702 is disposed between the seed laser stage and power amplifier stage. The pre-amplifier generally amplifies the output of a picosecond seed laser prior to power amplification such that the pulse power is generally within a favorable range for amplification by the fiber laser amplifier (or other suitable amplifier). Preferably, the pre-amplifier is also fiber based.

FIG. 7c illustrates yet a further configuration that includes modulator 703 disposed prior to power amplification. The modulator (e.g., a down-counter or divider) is generally used when the repetition rates are different between the power amplifier and seed laser. Usually, the repetition rate from a mode locked seed laser is relatively high, in the range of MHZ. However, as a result of rated average limited power the repetition rate requirement for the power amplifier may be in the range of a few to hundreds of KHz. Hence, the device operates as a “down-counter” or “pulse picker” (e.g., similar or identical to the modulator sub-system and optical switch of FIGS. 1a and 1b). Preferably, as with modulator sub-system 108, an optical switch is driven with control signals based on position and/or velocity information and therefore synchronized with other components of the laser processing system. An example of such a down-counting device can be an acoustic-optic modulator or other high speed optical switch. The device may be used alone or in combination with modulator 108 for selecting the pulses to be delivered to the link or other target structure. A wavelength shifter 105 may be disposed at the output as shown in FIGS. 7(a-c).

Referring to FIGS. 8(a-c), schematic block diagrams illustrating in further detail, constructions of exemplary laser systems which may be used in embodiments of the present invention are shown. By way of example, the seed laser may be a commercially available semiconductor laser diode and the amplifier system includes at least one fiber optic amplifier, and may include several stages of amplification.

FIG. 8a illustrates a seed laser with a multi-stage amplifier arrangement. Generally, the seeder (oscillator) generates pulses of picosecond duration (10 ps-1 ns) with an adjustable (i.e., modifiable, selectable, etc.) repetition rate up to 100 KHz or 10 MHZ. A typical unit may have 40-50 ps duration with a 100 KHz repetition rate. Both pre-amplifier and power amplifier stages are included. A fiber based, preferably single mode, pre-amplifier 8111 generally amplifies the pulses from the seeder to a level that leads to saturation in the final fiber power amplifier 8112 (which may be a multi-stage amplifier). The fiber based power amplifier is generally configured to produce output energy level in the range of about 5 microjoules to 50 microjoules, which is generally sufficient to remove the link with a single pulse and compensate for losses within an optical system. For an output wavelength of 1 micron, Ytterbium doped fiber is generally chosen. The fiber may be polarization-maintaining (PM) fiber.

FIG. 8b shows additional details of one construction of an alternative configuration which may be included in an embodiment of the invention. A modulated laser diode 821 may generate nanosecond pulses (two pulses 8211 shown, not to scale). Each of the pulses may be in an energy range of 1-200 nj, each with an exemplary pulse width of about 2-10 ns. A q-switched microlaser may be used as an alternative to the diode, and the tradeoffs between the choices may be based on specific design considerations and criteria. An isolator 831 is generally used to reduce the noise level, for instance noise caused by back reflection. The pulses are then amplified by diode pumped (pump diode(s) 824) and Yb amplifier 822. The amplification may be about 30 dB to raise the pulse energy to the microjoule range and to overcome various losses within the system.

A second isolator 831 is generally used to reduce the noise level caused by back reflection. A polarizer 826 is generally used to maintain the polarization of the beam to meet design criteria and Fiber Bragg Gratings (FBG) 825 are used as wavelength sensitive filters. The pulse width may then be “sliced” to the pico-second range using a very high speed GHz intensity modulator 827, preferably with a full-power band width of at least 10 GHz. Alternatively, a more efficient arrangement may be implemented with a Mach-Zehnder modulator as 827 wherein the nanosecond pulses are compressed to the picosecond range, producing a pulse width in the approximately 10 ps range. Amplified output pulse(s) 8271 are shown (not to scale) with removed or compressed portions depicted by dashed lines. In this case the amplifier 822 is operated at the final required repetition rate.

FIG. 8c shows details of a construction of an alternative seed-amplifier and “pulse picker” configuration which may be included in an embodiment of the invention. Overall, the configuration of FIG. 8c is similar to that of FIG. 7b, but without wavelength shifting, for instance. Pico-second pulses 8311 may be generated directly from a seed diode 829 or by external modulation (not shown) of a seed diode 829 at a multiple of the final required repetition rate (e.g., a multiple of 1-100 KHz). The pulse energy may typically be about 1 nj. As above, the signal is generally amplified (e.g., by about 30 db) with amplifier 8111, before the pulse repetition rate is reduced to the required final value by using a suitable modulator 1081 as a “down counter” or “pulse picker” (e.g., 1-100 KHz). The selected pulse(s) 8281 are shown.

The selected picosecond pulses 8281 may then be amplified with additional stages. FIG. 8d shows one of the configurations of a two-stage amplifier. As described above, components may include isolators 831 to reduce the noise level, a polarizer 826 to maintain the polarization of the beam, and Fiber Bragg Gratings 825 as wavelength filters. Both fiber amplifiers 841 and 842 are generally pumped by diodes (or diode arrays) 8411 and 8421 respectively. The first stage may be a 30 dB, single mode, Yb amplifier. The second stage may be a “large mode” or “large core” Yb amplifier with 30 dB gain. Various methods known in the art may be used to control the output mode and corresponding beam quality, and for noise (ASE) suppression (e.g., see U.S. Pat. Nos. 5,818,630 and 5,400,350, and WO 98/92050) so that a nearly diffraction limited output beam is produced for delivery to the link. The three-stage system of FIGS. 8c-8d may produce outputs in the range of tens—hundred microjoules with beam quality that is approximately diffraction limited.

Methods and systems of delivering pump energy to fiber amplifiers are well known. FIG. 8e shows, by way of example, one of the methods of coupling the diode laser energy into a fiber amplifier. Dichroic mirrors 850 in combination with an optical system (e.g., lens system) may transmit the pump light into Yb-doped, double clad fiber 851 through perpendicularly cleaved fiber ends 852. The amplifier output may be transmitted with a similar dichroic arrangement wherein pump energy 855 is recirculated through fiber. Skilled persons will appreciate and understand other possible appropriate combinations of different types of laser sources for seed and amplifier lasers may be implemented to meet the design criteria of a particular application.

Memory Repair System

Referring to FIG. 9, a block diagram of a laser based memory repair system, including a pico-second laser system, and further illustrating numerous major system components of the present invention is shown.

Complete micromachining stations using pico second lasers may be implemented. At least one embodiment of a picosecond laser system may be integrated into the M430 series manufactured by GSI Lumonics, or other micromachining systems having suitable sub-micron tolerances and performance specifications for high speed micromachining. The following list of attached patents and published applications, assigned to the assignee of the present invention, describe numerous aspects related the memory repair methods and systems:

1. U.S. Pat. No. 5,300,756, entitled “Method and System for Severing Integrated-Circuit Connection Paths by a Phase Plate Adjusted Laser beam”;

2. U.S. Pat. No. 6,144,118, entitled “High Speed Precision Positioning Apparatus”;

3. U.S. Pat. No. 6,181,728, entitled “Controlling Laser Polarization”;

4. U.S. Pat. No. 5,998,759, entitled “Laser Processing”;

5. U.S. Pat. No. 6,281,471, entitled “Energy Efficient, Laser-Based Method and System for Processing Target Material”;

6. U.S. Pat. No. 6,340,806, entitled “Energy-Efficient Method and System for Processing Target Material Using an Amplified, Wavelength-Shifted Pulse Train”;

7. U.S. application Ser. No. 09/572,925, entitled “Method and System For Precisely Positioning A Waist of A Material-Processing Laser Beam To Process Microstructures Within A Laser-Processing Site”, filed May 16, 2000, and published as WO 0187534 A2, December, 2001, now U.S. Pat. No. 6,483,071, Division of Ser. No. 09/572.925;

8. U.S. Pat. No. 6,300,590, entitled “Laser Processing”; and

9. U.S. Pat. No. 6,339,604, entitled “Pulse Control in Laser Systems”.

As apparent from the teachings herein the present invention provides for processing of links with pitch of less than 2 microns with a negligible heat affected zone, and without the complexity of a femtosecond laser system. Precise link removal may be facilitated with one or more picosecond pulses. Further, link removal may be accomplished with high efficiency when compared to a slow etching process, and with improved precision when compared to conventional nanosecond link processing approaches. Link processing in accordance with the present invention may be carried out in a high speed laser processing system.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A laser-based system for processing target material within a microscopic region without causing undesirable changes in electrical or physical characteristics of at least one material surrounding the target material, the system comprising:
a seed laser for generating a sequence of laser pulses having a first pre-determined wavelength;
an optical amplifier for amplifying at least a portion of the sequence of pulses to obtain an amplified sequence of output pulses; and
a beam delivery system for delivering and focusing at least one pulse of the amplified sequence of pulses onto the target material, the at least one output pulse having a pulse duration in the range of about 10 picoseconds to less than 1 nanosecond, the pulse duration being within a thermal processing range, and the at least one focused output pulse having sufficient power density at a location within the target material to reduce the reflectivity of the target material and efficiently couple the focused output into the target material to remove the target material.

2. The system of claim 1 wherein the beam delivery system further comprises a deflector for delivering the sequence of pulses.

3. The system of claim 1 wherein the beam delivery system includes an anamorphic optical sub-system for producing a non-round focused output pulse.

4. The system of claim 1 further comprising a pre-amplifier for pre-amplifying the seed laser sequence to a predetermined pulse energy level prior to the optical amplifying.

5. The system of claim 1 further comprising a shifter for shifting the first wavelength to a second wavelength prior to the optical amplifying.

6. The system of claim 1 further comprising a modulator for controllably selecting at least a portion of the amplified sequence of pulses based on position or velocity information to synchronize a link and laser beam position during relative motion so as to provide the at least one output pulse subsequent to the optical amplifying.

7. The system of claim 1 further comprising a modulator for controllably selecting at least a portion of the sequence of pulses based on position or velocity information to synchronize a link and laser beam position during relative motion so as to provide at least one pulse to process the target link on demand prior to the optical amplifying.

8. The system of claim 6 wherein the sequence of laser pulses has a repetition rate that is greater than about 1 MHz and wherein a modulator controllably selects the sequence of pulses to reduce the repetition rate to within the range of about 10 Khz to 100 Khz.

9. The system of claim 1 wherein the sequence of laser pulses includes at least one pulse having a nanosecond duration greater than about 1 nanosecond, and the system further includes a modulator for compressing or slicing the at least one nanosecond pulse to produce a pulse having the duration in the range of about 10 ps to less than 1 ns.

10. The system of claim 9 wherein the at least one seed laser is a q-switched microlaser or laser diode.

11. The system of claim 9 wherein the modulator is a compressor disposed between the seed laser and the amplifier and compressing is performed prior to amplifying.

12. The system of claim 9 wherein the modulator is a slicer disposed after the amplifier and slicing is performed subsequent to amplifying.

13. The system of claim 1 wherein the seed laser is diode pumped solid state laser.

14. The system of claim 13 wherein the diode pumped solid-state laser is a fiber laser.

15. The system of claim 1 wherein the seed laser is an active or passive mode locked laser.

16. The system of claim 1 wherein the seed laser is a high speed semiconductor laser diode.

17. The system of claim 1 wherein amplifying is performed using at least one fiber optic amplifier.

18. The system of claim 17 wherein the fiber optic amplifier has gain of about 30 dB.

19. The system of claim 1 further comprising a shifter for shifting the laser wavelength of at least one pulse of the amplified sequence of pulses from the first wavelength to a second wavelength less than about one micron.

20. A laser-based system, for processing target material within a microscopic region without causing undesirable changes in electrical or physical characteristics of at least one material surrounding the target material, the system comprising:
means for generating a sequence of laser pulses, each pulse of the sequence of pulses having a pulse duration in the range of about 10 picoseconds to less than 1 nanosecond, the pulse duration being within a thermal processing range;
modulator means for controllably selecting at least a portion of the sequence of pulses to provide at least one output pulse to process the target material on demand; and
means for delivering and focusing the at least one output pulse onto the target material comprising an optical system, the at least one focused output pulse having sufficient power density at a location within the target material to reduce the reflectivity of the target material and efficiently couple the focused output into the target material to remove the target material.

21. The system of claim 20 wherein the sequence of laser pulses is an amplified sequence of pulses, and wherein the means for generating includes a master oscillator and power amplifier (MOPA).

22. The system of claim 20 wherein modulator means includes an acousto-optic modulator or electro-optic modulator.

23. The system of claim 22 wherein the electro-optic modulator is a Mach-Zehnder modulator.

24. The system of claim 20 wherein the means for delivery includes a beam deflector for deflecting at least one pulse to the target material based on at least of one position and velocity information of the target material relative to the at least one pulse.

25. A laser-based system for processing target material within a microscopic region without causing undesirable changes in electrical or physical characteristics of at least one material surrounding the target material, the system comprising:
a first laser and a second laser for producing a plurality laser pulses having a temporal spacing between the pulses;
a beam combiner for combining the pulses;
at least one optical amplifier for amplifying at least a portion of the plurality of pulses;
a controller for controlling the temporal spacing of the pulses based on a predetermined physical property of the target material; and
a beam delivery system for delivering and focusing at least one amplified pulse onto the target material, the at least one output pulse having a pulse duration in the range of about 10 picoseconds to less than 1 nanosecond, the pulse duration being within a thermal processing range, and the at least one focused output pulse having sufficient power density at a location within the target material to reduce the reflectivity of the target material and efficiently couple the focused output into the target material to remove the target material.

26. The system of claim 25 wherein the system controller further comprises a delay line.

27. The system of claim 25 wherein the predetermined physical property comprises a differential thermal property.

28. The system of claim 25 wherein the predetermined physical property comprises dissipation of vapor plasma plume.

29. The system of claim 25 wherein the amplifier is a fiberoptic amplifier.

30. The system of claim 25 wherein at least one of the first and second lasers is a diode pumped fiber laser oscillator.

31. The system of claim 25 wherein at least one of the first and second lasers is a semiconductor laser diode.

32. The system of claim 25 wherein temporal spacing is the range of about 2 nanoseconds to 10 nanoseconds.
